(19) United States
(12) Patent Application Publication
(10) Pub. No.: US 2009/0206497 A1
(43) Pub. Date: Aug. 20, 2009

(54) LIQUID WASTE AERATION SYSTEM AND METHOD

(76) Inventor: William R. Nelson, La Conner, WA (US)

Correspondence Address: AXIOS LAW GROUP. PLLC, 1525 4TH AVE, STE 800, SEATTLE, WA, 98101-1648, US

(21) Appl. No.: 12/372,688

(22) Filed: Feb. 17, 2009

Related U.S. Application Data
(60) Provisional application No. 61/029,303, filed on Feb. 15, 2008.

(51) Int. Cl. B01F 3/04

(52) U.S. Cl. 261/36.1; 210/758; 210/220; 261/76; 261/120; 261/123; 261/DIG. 75

(57) ABSTRACT

Systems and methods are disclosed herein that provide for liquid waste aeration.

### RELATED REFERENCES

This application claims priority to U.S. Provisional Application 61/029,303 Entitled “LIQUID WASTE AERATION SYSTEM AND METHOD filed Feb. 15, 2008. The foregoing application is hereby incorporated by reference in its entirety as if fully set forth herein.

### FIELD

This invention relates generally to waste management, and more specifically, to systems and methods for liquid waste aeration.

### BACKGROUND

Aeration or oxygenation is a common step in the treatment of waste water and sewage. By dissolving, suspending, or otherwise introducing oxygen to waste water, an aerobic environment is generated, which promotes oxidation and microbial consumption of waste materials. There are many systems that assist in aerating waste water; however, often these systems are deficient because, among other reasons, they may be cumbersome, consume large amounts of energy, and fail to efficiently introduce oxygen to the waste water. Exemplary systems in this regard include U.S. Pat. No. 3,671,022 to Laird et al.; U.S. Pat. No. 3,799,515 to Geerlings; U.S. Pat. No. 4,152,259 to Molvar; U.S. Pat. No. 3,320,928 to Smith; U.S. Pat. No. 6,398,194 to Tsai et al.; U.S. Pat. No. 5.938,983 to Sheaffer et al.; and U.S. Pat. No. 5,057,230 to Race.

Additionally, waste water ponds and aeration systems are periodically emptied for cleaning and waste removal. Many aeration systems have structures that are permanently or semi-permanently affixed to a waste water pond, which makes draining and cleaning such a pond an expensive and time consuming process. (See e.g. U.S. Pat. No. 3,671,022 to Laird et al.; U.S. Pat. No. 6,398,194 to Tsai et al; and U.S. Pat. No. 5,057,230 to Race).

Some existing aeration systems use partially submerged rotating brushes that are positioned on the surface of the ponds. These brushes introduce atmospheric air to the pond as the brushes rotate and churn the surface of the water and propel the water into the air. In such systems, large motors are required to rotate these heavy brushes, therefore consuming large amounts of energy. These structures are installed on concrete or steel pedestals which are costly to install and may not be moved thereafter. Additionally, the systems fail to aerate water that is not near the surface of the pond. (See e.g. U.S. Pat. No. 3,799,515 to Geerlings).

Other methods use air stones attached to a manifold that is bolted to the bottom of a tank or pond. An on-shore air compressor feeds compressed air through a hose to the manifold on which the air stones are attached. Again, the compressor consumes high amounts of energy and the installation is expensive and permanent. Moreover, bubbles that escape the air stones on the bottom tend to be large bubbles that rise to the surface quickly, which fails to efficiently introduce oxygen to the system.

Still further systems feed air to a manifold that has holes in it. Such systems may be secured to the bottom of an aeration pond to prevent manifold flotation, or may be positioned on the water surface with aeration pipes extending towards the bottom of the pond. Regardless, these systems are costly to install and require great amounts of energy to pump the air through the manifold. Moreover, as with others, these systems do not get oxygen to the bottom of a pond and bubbles that are produced are typically large and therefore rise to the surface of the pond quickly. Accordingly, aeration is not efficient, especially in light of energy consumption.

Other systems use nozzles and a venturi to disperse atmospheric air bubbles into a pond. Here, pumps suck the water from the bottom of a pond to the shore or the top of the pond, the water is treated with atmospheric air through the venturi, and then pumped back to the bottom via a pipe or manifold. Again, large pumps are required in such a system, which consume a large amount of energy. Additionally, the architecture submerged in the pond tends to clog, which requires periodic cleaning and maintenance, which may also be costly and cumbersome.

Similar systems comprise a submersible pump positioned on the bottom of an aeration pond, which pumps water to the surface, through a venturi, and back to the bottom of a pond through a nozzle. Such systems also require periodic maintenance and cleaning and lack efficiency.

Accordingly, there still exists a need in the art for new aeration systems and methods. The present invention fulfills these needs and provides further related advantages.

### BRIEF DESCRIPTION OF THE DRAWINGS

The present disclosure will be presented by way of exemplary embodiments but not limitations, illustrated in the accompanying drawings in which like references denote similar elements, and in which:

FIG. 1a is a side view of an exemplary liquid waste aeration system, in accordance with an embodiment.

FIG. 1b is a side view of an exemplary liquid waste aeration system, in accordance with another embodiment.

FIG. 1c is a side view of an exemplary liquid waste aeration system, in accordance with a further embodiment.

FIG. 2a is a enlarged side view of an exemplary liquid waste aeration pod, in accordance with an embodiment.

FIG. 2b is a enlarged side view of an exemplary liquid waste aeration pod, in accordance with another embodiment.

FIG. 2c is a enlarged sideview of an exemplary liquid waste aeration pod, in accordance with a further embodiment.

FIG. 3 is a cross section view of an exemplary liquid waste aeration pod, in accordance with an embodiment.

FIG. 4a is a cross section view of an exemplary liquid waste aeration pod, in accordance with an embodiment.

FIG. 4b is a cross section view of an exemplary liquid waste aeration pod, in accordance with another embodiment.

FIG. 4c is a cross section view of an exemplary liquid waste aeration pod, in accordance with a further embodiment.

FIG. 4d is a cross section view of an exemplary liquid waste aeration pod, in accordance with a still further embodiment.

FIG. 5a is a perspective view of a pod base, in accordance with an embodiment.

FIG. 5b is a perspective view of a pod base, in accordance with another embodiment.

FIG. 5c is a perspective view of a pod base, in accordance with a further embodiment.

FIG. 6 is a block diagram illustrating a liquid aeration method, in accordance with an embodiment.

### DESCRIPTION

Illustrative embodiments presented herein include, but are not limited to, systems and methods for liquid waste aeration.

Various aspects of the illustrative embodiments will be described using terms commonly employed by those skilled in the art to convey the substance of their work to others skilled in the art. However, it will be apparent to those skilled in the art that the embodiments described herein may be practiced with only some of the described aspects. For purposes of explanation, specific numbers, materials and configurations are set forth in order to provide a thorough understanding of the illustrative embodiments. However, it will be apparent to one skilled in the art that the embodiments described herein may be practiced without the specific details. In other instances, well-known features are omitted or simplified in order not to obscure the illustrative embodiments.

Further, various operations will be described as multiple discrete operations, in turn, in a manner that is most helpful in understanding the embodiments described herein; however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising,” “having” and “including” are synonymous, unless the context dictates otherwise.

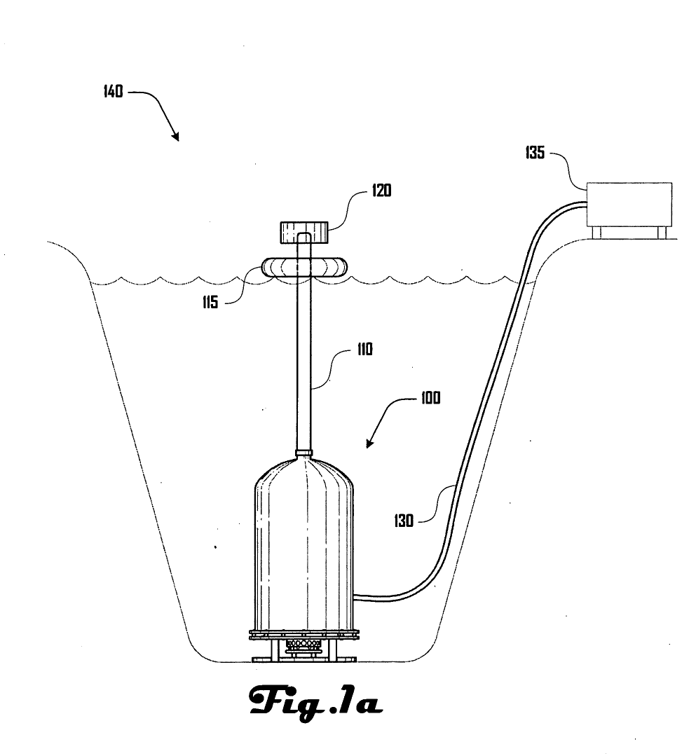

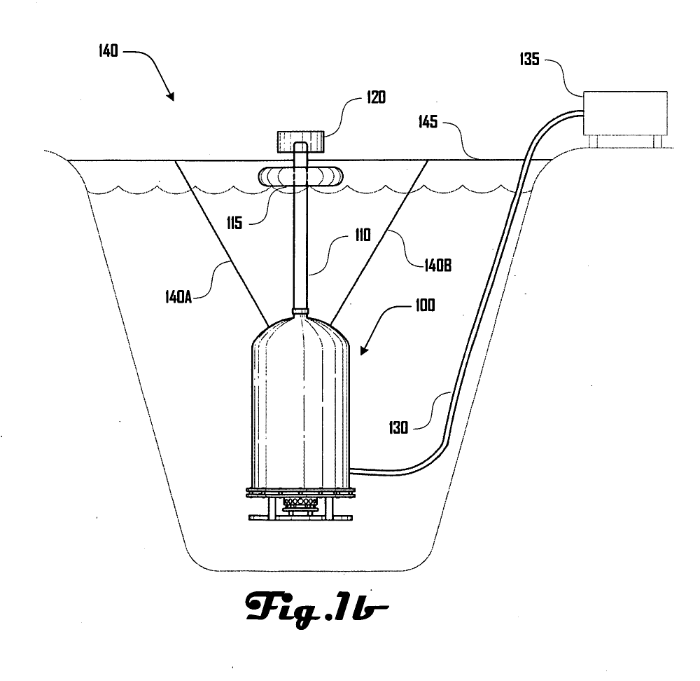

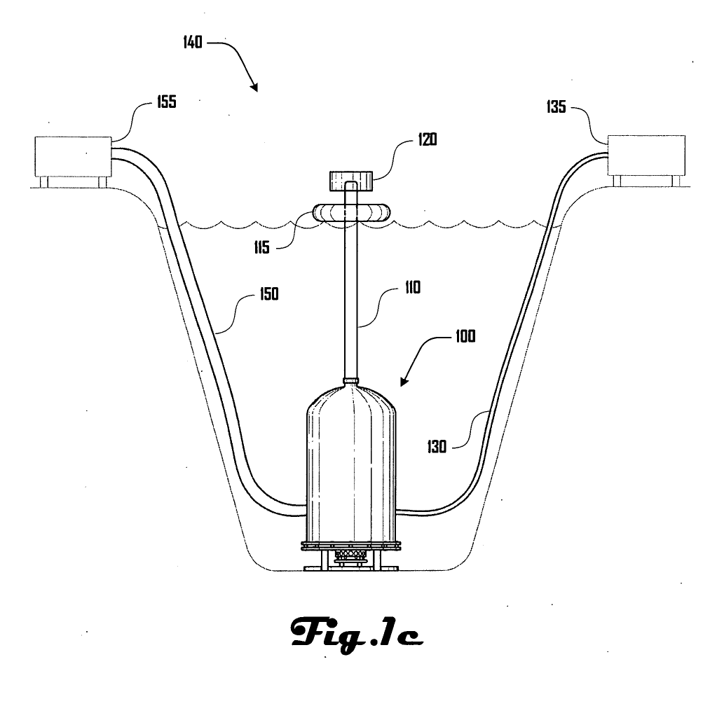

FIGS. 1a, 1b and 1c depict sideviews of an exemplary liquid waste aeration system, in accordance with various embodiments. The depicted system comprises an aeration pod 100, an air intake tube 110, an air tube snorkel float 115, an air tube snorkel cap 120, a power cord 130, and a power source 135, which are all located in and about a liquid waste pond 140.

Additionally, FIGS. 1a, 1b and 1c depict an aeration pod 100 in accordance with various embodiments, wherein the aeration pod 100 is submerged in a liquid waste water pond 140. In various embodiments, the aeration pod 100 may be located in various bodies of liquid, which may include a liquid waste water pond 140.

Also depicted is an air intake tube 110 coupled to a top end of the aeration pod 100. The air intake tube 110 extends to the surface of the liquid waste pond 140, where an air tube snorkel float 115 supports the air intake tube 110. The air intake tube 110 is covered by an air tube snorkel cap 120.

In one embodiment, the air tube snorkel float 115 is a buoyant member that is coupled to the air intake tube 110 that allows the distal end of the air intake tube 110 that is covered by the air tube snorkel cap 120 to remain above the surface of the liquid waste pond 140. The air tube snorkel float 115 may be various types of buoyant members, which may include an inflatable member, or a member comprising Styrofoam, or the like.

In a further embodiment, the air tube snorkel cap 120 is configured to allow air to enter the air intake tube 110, while also providing a barrier that reduces or prevents particulate matter and/or liquids from entering the orifice of the air intake tube 110 that is covered by the air tube snorkel cap 120. Various configurations and systems may provide for an air-intake as described herein and such configurations and systems are within the scope of various embodiments.

Also depicted in FIGS. 1a, 1b and 1c is power cord 130 and a power source 135, which are associated with the aeration pod 100. The power cord 130 provides power to the aeration pod 100, which may be obtained from the power source 135. The power source 135 may be various types of energy sources, which may include a generator; a junction with an electrical power source, a solar power generator, a hydrogen generator, or the like.

In one embodiment, the power cord 130 may be contained within the air intake tube 110, or be coupled to the exterior of the air intake tube 110. In another embodiment, the power cord 130 need not be coupled to the air intake tube 110. In a still further embodiment, the power cord 130 and power source 135 may be absent, and the aeration pod 100 may be powered in various types of ways, which may include battery power, nuclear power, or the like.

FIG. 1a, depicts an aeration pod 100 resting on the bottom of a liquid waste pond 140, whereas FIG. 1b depicts an aeration pod 100 suspended in a liquid waste pond 140 via a support member 145 and a first and second support line 140A, 140B.

In some embodiments, it may be desirable for an aeration pod 100 to reside on the bottom of a liquid waste pond 140 as depicted in FIG. 1a. For example, where the bottom of the liquid waste pond 140 is relatively free of debris that may impede the function of the aeration pod 100, positioning the aeration pod 100 on the bottom of the aeration pod 100 may be desirable.

Additionally, in some embodiments, the liquid waste aeration pod 100 may be operable to break, liquefy, chop, or otherwise accomidate debris that may be present on the bottom of a liquid waste pond 140 and therefore positioning the aeration pod 100 on the bottom of the liquid waste pond 140 may be desirable.

In other embodiments, it may be desirable to suspend an aeration pod 100 off the bottom of a liquid waste pond 140. For example, where there is debris or other solid material located at the bottom of the liquid waste pond 140 that may impede the function of the aeration pod 100, it may be desirable to suspend the aeration pod 100 above the bottom of the liquid waste pond 140.

In some embodiments an aeration pod 100 may be suspended various distances above the bottom of a liquid waste pond 140. For example, between 5 and 15 feet; between 5 and 30 feet, between 10 and 25 feet, approximately 10 feet, approximately 5 feet, and the like.

In FIGS. 1a and 1b, the aeration pod 100 is operable to expel liquid comprising bubbles (not shown) from a plurality of nozzles 290 at the bottom of the aeration pod 100. In various embodiments, expelled bubbles may be micro-bubbles, which may include bubbles having a diameter less than 15 microns less than 25 microns, less than 50 microns, less than 100 microns, less than 200 microns, less than 500 microns, and the like. In some embodiments, bubbles may be nano-bubbles or fine bubbles.

In FIGS. 1c, the aeration pod 100 may be operable to generate bubbles in liquid within the aeration pod 100, and this liquid and bubble mixture may be removed from the aeration pod 100 via an exit tube 150. The exit tube 155 may be connected to an exit pump 155, which is operable to pump liquid, gas, and mixtures thereof from the aeration pod 100. In various embodiments, liquid and gas mixtures may be pumped from the aeration pod 100, and such mixtures may be treated, cleaned, filtered, process, or used for various purposes.

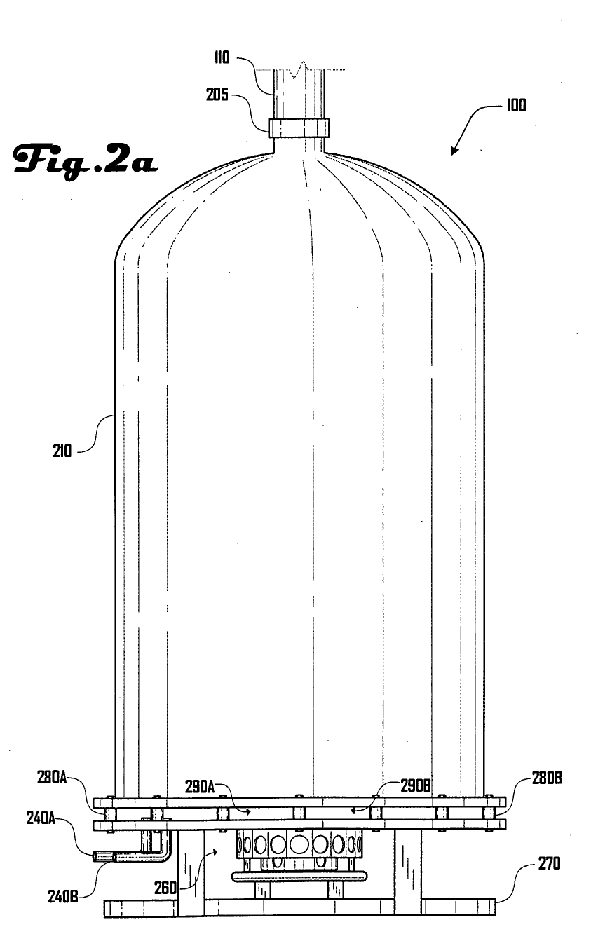

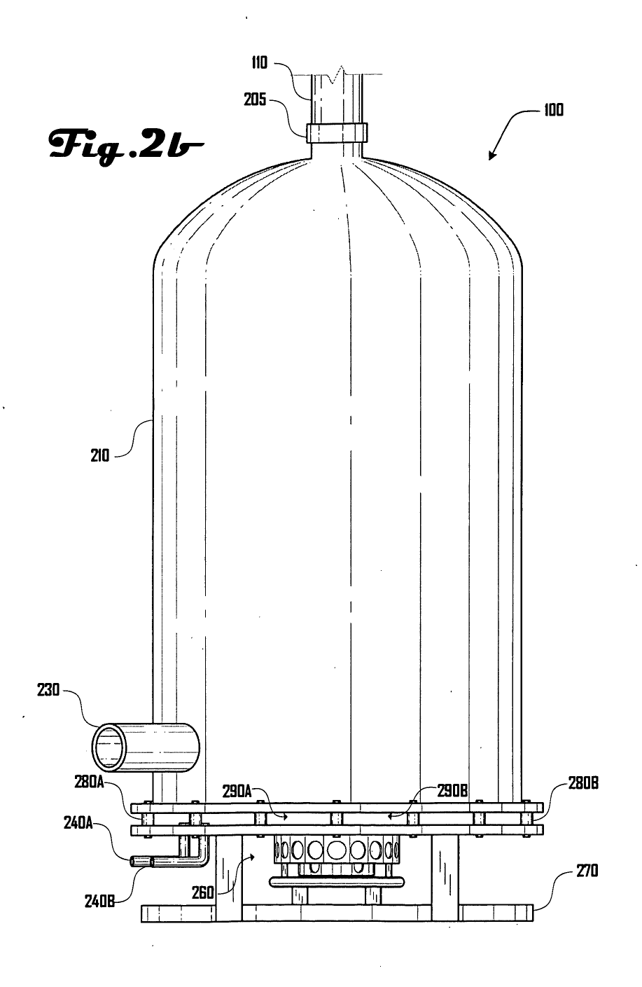

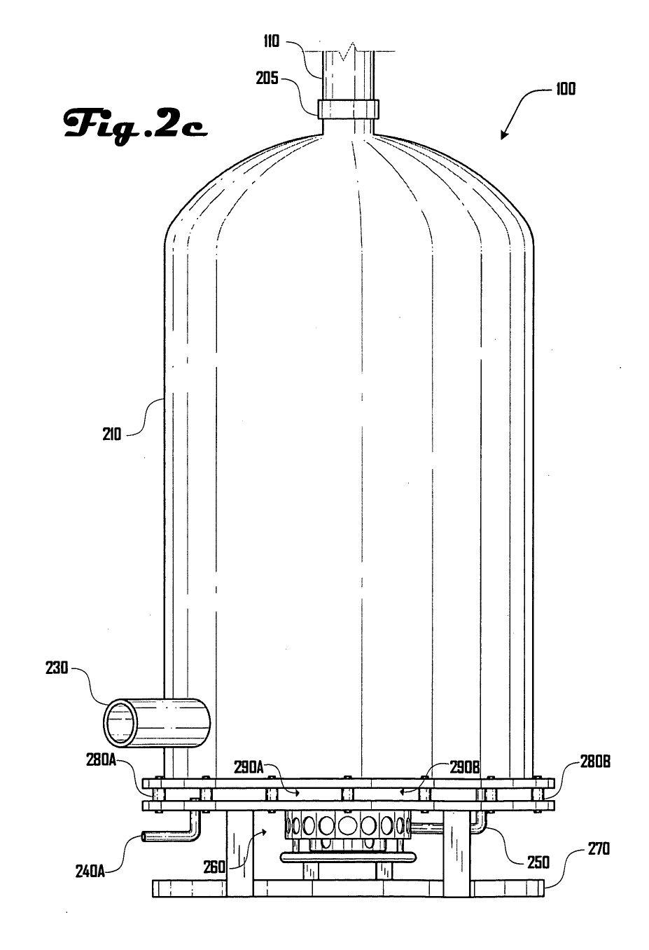

FIGS. 2a, 2b and 2c depict a close-up environmental view of an aeration pod 100 in accordance with various embodiments. The aeration pod 100 comprises an air intake tube 110, an air intake tube coupling member 205 a pod shell 210, one or more injection port 240A, 240B, an intake screen 260, a pod base 270, a plurality of base coupling spacers 280A, 280B, and a plurality of ejection nozzles 290A, 290B. In some embodiments, the aeration pod 100 comprises a shell port 230. In some embodiments, the aeration pod 100 comprises a circulation tube 250.

The pod shell 210 may define an internal space within the aeration pod 100, which facilitates separation of matter between the inside and outside of the aeration pod 100. In various embodiments, the pod shell 210 may define an internal space wherein liquid and gas may be combined or mixed and further provide a space wherein various components of the aeration pod 100 may reside. Additionally, the pod shell 210 may comprise or define plurality of ejection nozzles 290A, 290B which allow matter to pass between the outside and inside of the aeration pod 100.

For example, the pod base 270 comprises the intake screen 260, and a plurality of base coupling spacers 280A, 280B. The base coupling spacers 280A, 280B are positioned about the circumference of the top end of pod base 270 and facilitate the coupling of the pod shell 210 to the pod base 270. The coupling of the pod shell 210 to the pod base 270 is achieved via bolts in one embodiment; however, various methods of coupling the pod shell 210 to the pod base 270, either permanently, semi-permanently, or temporarily are within the scope and spirit of various embodiments.

The pod shell 210 rests upon the base coupling spacers 280A, 280B, whereby the pod shell 210, base coupling spacers 280A, 280B, and top end of the pod base 270 define a plurality of ejection nozzles 290A, 290B, or orifices that allow liquid and other matter to pass from between the inside of the pod shell 210 and the outside of the pod shell 210.

As depicted in FIGS. 2a and 2b, the aeration pod 100 further comprises two injection ports 240A 240B, which may be an orifice or tube that allows gasses, liquids, and/or solids to be directed into the cavity defined by the pod shell 210. For example, in one embodiment, a tube may be coupled to one or more injection port 240A 240B and gases, liquids, solids, a combination thereof, or the like, may be pumped, injected, or sucked into the aeration pod 100.

In other embodiments, an injection port 240 may be absent, or there may be various numbers of injection ports 240. For example, as depicted in FIG. 2c, there may be only one injection port 240A. In some embodiments, it may be desirable to have two injection ports 240A, 240B so that two different types of material may be introduced to the aeration pod 100. For example, one injection port 240A may facilitate adjustment of the liquid pH and the other injection port 240B may facilitate introduction of a flocculent. In some embodiments, an injection port 240 may be located in various positions about the aeration pod 100, such as near the top or bottom of the pod shell 210, and the like.

Additionally, the pod base 270 includes an intake screen 260, which comprises a plurality of orifices defined by the intake screen 260 that allow liquids and other matter to be sucked, pumped or passed between the outside of the pod shell 210 and the inside of the pod shell 210. In various embodiments, further described herein, liquid may be sucked in through the intake screen 260 by a pump apparatus 310.

In some embodiments, such as the embodiment depicted in FIG. 2c, the pod shell 210 may separate liquids and/or gasses on the outside of the aeration pod 100 from liquids and/or gasses on the inside of the aeration pod 100. The shell port 230 defines an orifice in the pod shell 210, and the shell port 230 may be an open orifice, be closed, or be capped in various ways, or an exit tube 150 or other member may be attached to the shell port 230. For example, in one embodiment, the shell port 230 may be coupled with an exit tube 150 that allows liquids from inside the pod shell 210 to be pumped, discharged or sucked to a filtering system. In such an embodiment, the ejection nozzles 290 may be absent along with the base coupling spacers 280, and therefore liquids and liquids infused with micro bubbles will only leave the pod shell 210 via the shell port. In various embodiments, the shell port 230 may be absent.

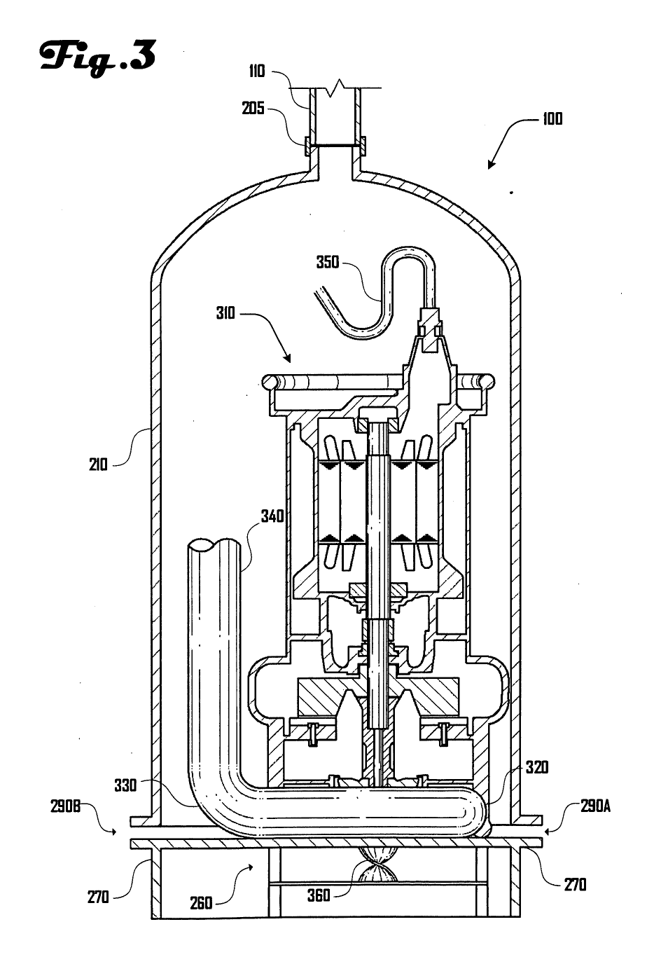

FIG. 3 is a cross sectional view of an exemplary aeration pod 100, in accordance with an embodiment. Various elements and aspects of the aeration pod are not depicted in FIG. 3 or depicted partially so as not to obscure elements or aspects being described and shown in FIG. 3.

The aeration pod 100 comprises an air intake tube 110, an air intake tube coupling member 205, a pod shell 210, an intake screen 260, a pod base 270, and a plurality of ejection nozzles 290A, 290B. Additionally, within the cavity defined by the pod shell 210, the aeration pod 100 further comprises a pump apparatus 310, a first pipe length 320, a first pipe sweep 330, a second pipe length 340, and a pump apparatus power cord 350. The pump apparatus 310 further comprises an agitator 360.

As depicted in FIG. 3, the pump apparatus 310 may be positioned within the cavity defined by the pod shell 210, and may be coupled to the pod base 270 via various means including bolts, welding, and the like. The pump apparatus 310 comprises an agitator 360 which extends via a pump shaft into the intake screen 260, and the intake screen 260 encircles the agitator 360. The agitator 360 may break up solids or other matter passing into the pump apparatus 310, and may serve to clean the intake screen 260. In one embodiment, a cutter may be present that may further cut solids and other matter that is passing into the pump apparatus 310. For example, the cutter may be part of the pump apparatus 310, and be positioned between the agitator 360 and a pump impeller. In a further embodiment, the agitator 360 may be absent.

In some embodiments, the pump apparatus 310 may be various types of pumps, which may include a submersible pump apparatus 310. In one embodiment, the pump apparatus 310 may be a submersible pump manufactured by Toyo Pump (Sumptech/Toyo Pump, Taichung, Taiwan). In some embodiments, a pump may be ¾ horsepower, 2 horsepower, 4 horsepower, 7.5 horsepower, 15 horsepower, and the like. Various pumps of various sizes and configurations may be used, which are within the scope and spirit of various embodiments.

Moreover, it should be clear that various aspects of an aeration pod 100 may be modified and or configured to accommodate such pumps. For example, some pumps may have a power cord 350 in a different position, or water may be expelled from the pump into a first pipe length 320, a pre-venturi pipe sweep 410, a venture member 430, or the like, that is located on the top, bottom side or elsewhere on a pump. Various and different pump sizes, shapes, and configurations are within the scope and spirit of various embodiments, including specific embodiments shown and described herein.

Returning to FIG. 3, there is a first pipe length 320, coupled to the pump apparatus 310, which proceeds to a first pipe sweep 330 and proceeds to a second pipe length 340. In FIG. 3, only a portion of the second pipe length 340 is illustrated so as not to obscure other elements of the aeration pod 100. When in operation, the pump apparatus 310 may pump liquid through the intake screen 260 and the agitator 360 and into the first pipe length 320, which is coupled to the pump apparatus 310. The liquid then proceeds through the first pipe sweep 330, and into the second pipe length 340. Further actions are discussed in the following Figures.

The pump apparatus 310 further comprises a pump apparatus power cord 350, which provides the pump apparatus 310 with electrical power. FIG. 3 depicts a portion of the pump apparatus power cord 350; however, the pump apparatus power cord 350 may be of various lengths. In one embodiment, the pump apparatus power cord 350 may pass through the pod shell 210, pod base 270, through the air intake tube 110, and the like, and may be connected to a power source 135. Providing a pump apparatus 310 with energy or power may be achieved in numerous ways and in various configurations, which are each within the scope of various embodiments. For example, in some embodiments, a pump apparatus 310 may be powered via solar panels.

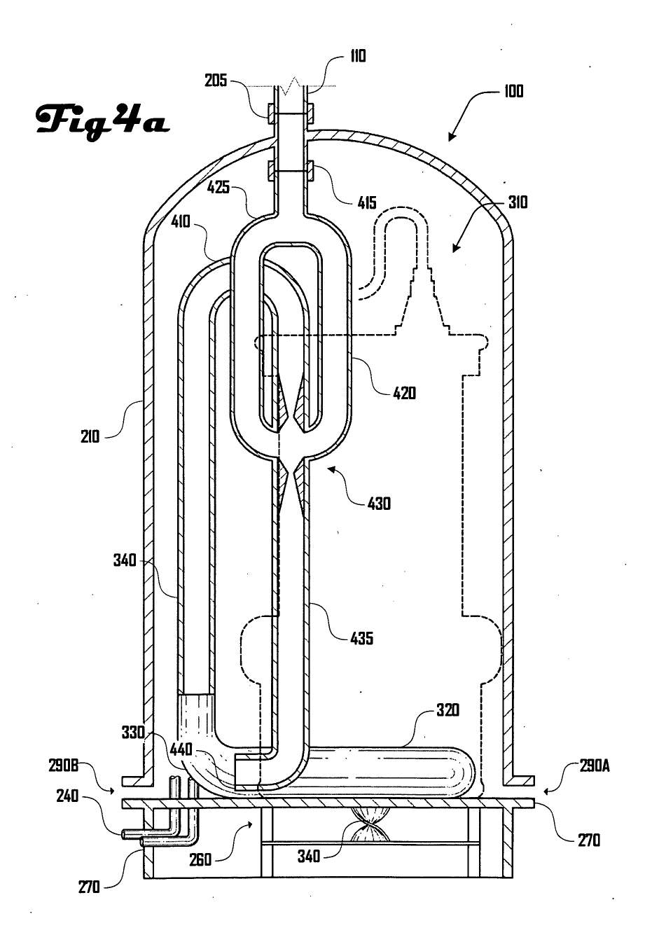

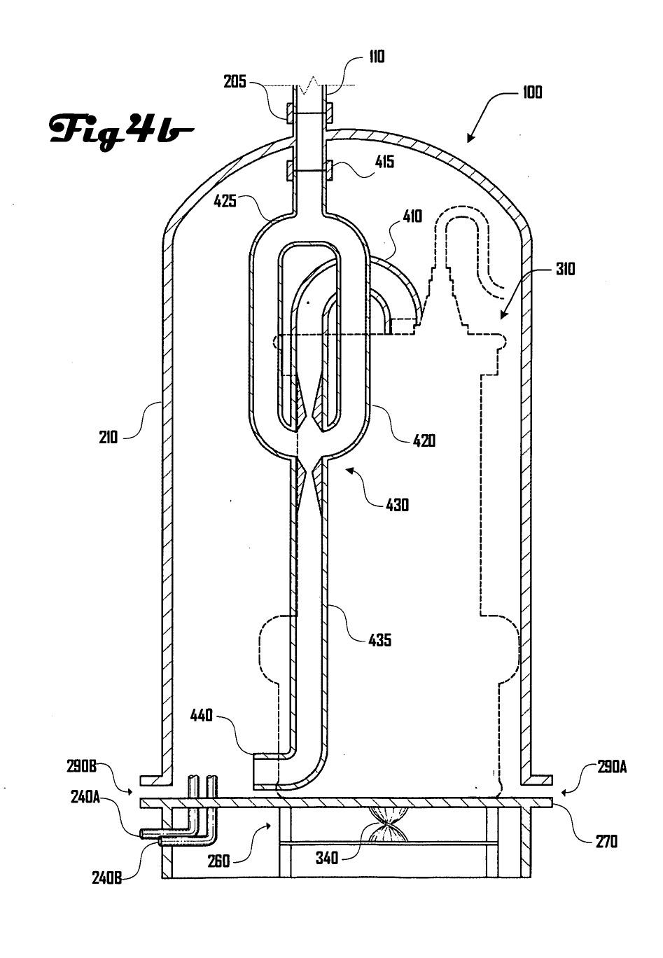

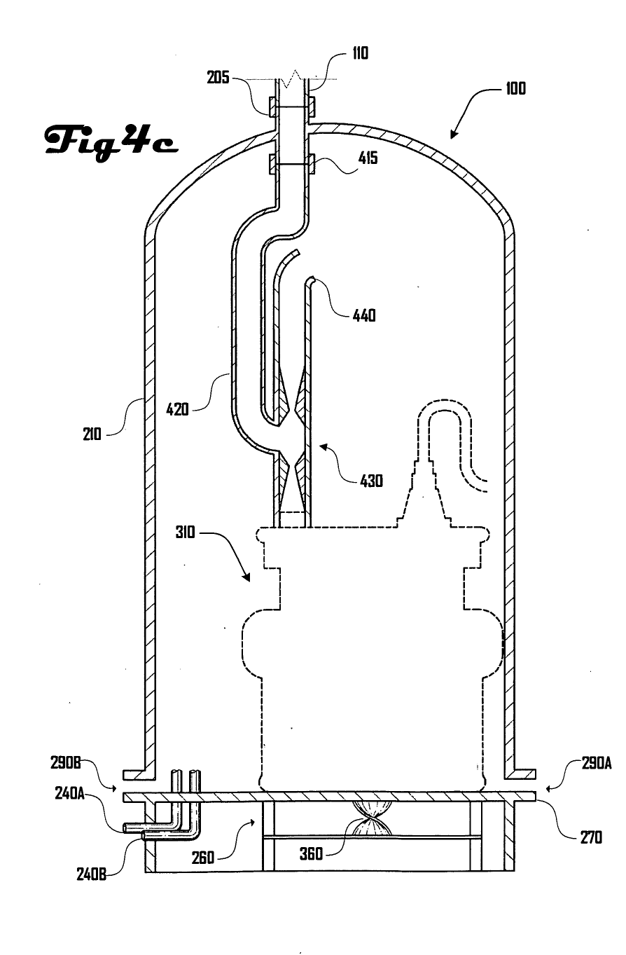

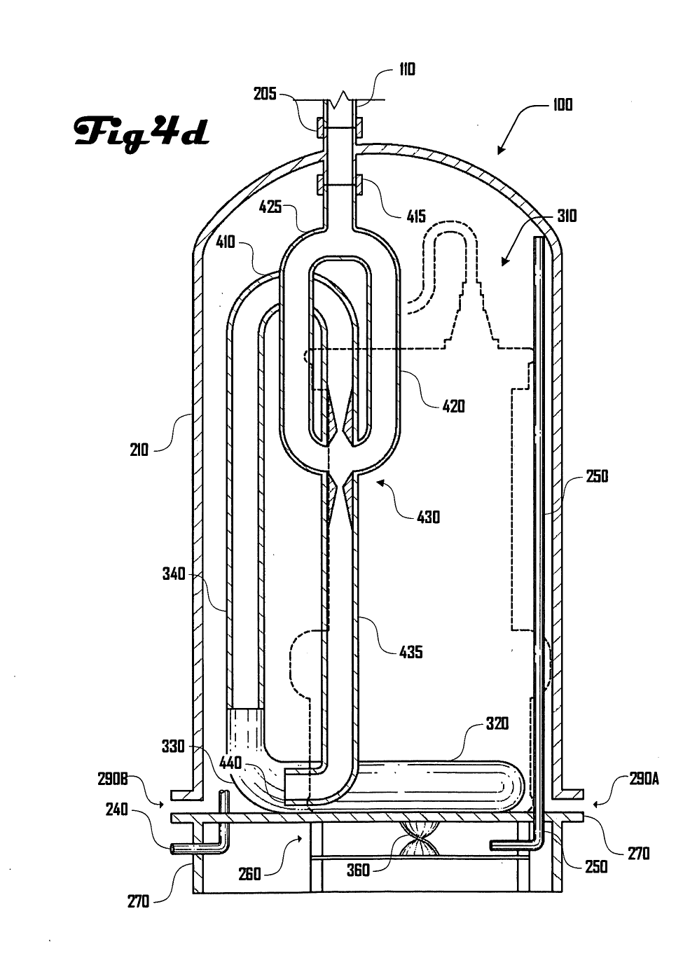

FIGS. 4a-4d depict cross sectional views of exemplary aeration pods 100 in accordance with various embodiments. The aeration pod 100 comprises an air intake tube 110, an air intake tube coupling member 205, a pod shell 210, one or more injection port 240A, 240B, an intake screen 260, a pod base 270, and a plurality of ejection nozzles 290A 290B. Additionally, within the cavity defined by the pod shell 210, the aeration pod 100 further comprises a pump apparatus 310, which itself comprises a pump apparatus power cord 350 and an agitator 360. In some embodiments, there may be a circulation tube 250.

FIG. 2a depicts an aeration pod 100 further comprising a first pipe length 320, a first pipe sweep 330, a second pipe length 340, a pre-venturi pipe sweep 410, an internal intake tube coupling member 415, a first intake tube branch 425, a second intake tube branch 420, a venturi member 430, a third pipe length 435, an extrusion orifice 440.

As discussed herein, the pump apparatus 310, sucks liquid through the intake screen 260, past the agitator 340, and pumps the liquid into the first pipe length 320. The liquid then continues through the first pipe sweep 330, up through the second pipe length 340, and then through the pre-venturi pipe sweep 410. The liquid then enters the venturi member 430, which comprises a narrowing pipe that is coupled to a first and second intake tube branch 420, 425 that are coupled with the air intake tube 110 via an internal intake tube coupling member 415 and an external air intake tube coupling member 205.

In one embodiment, the venturi member 430 is a mixer-injector that has a body with a flow passage therethrough. The flow passage has an entry port, and exit port, and a circularly-sectioned wall extending along a central axis between the two ports. The wall includes a first and second entry portion that extends from the entry port and is substantially cylindrical. The first and second entry portions are coupled to the first and second intake tube branch 420, 425 respectively. The venturi member 430 further includes a constricting portion that is may be frusto-conical, with a diameter which lessens as the constricting portion extends away from the entry portion. The constricting portion extends to an injection portion located at the smaller end of the constricting portion.

The injection portion may be substantially cylindrical, extending from its intersection with the constricting portion to its intersection with an expanding portion. An injection port enters the flow passage immediately adjacent to the intersection with the constricting portion and the injection portion. The expanding portion may be frusto-conical, with a diameter that increases as it extends away from the injection portion. The expanding portion extends to the exit port.

Where liquid is flowing through the venturi member 430 via the entry and exit port, and where the first and second entry portions are filled with gas, a “Venturi effect” results (Giovanni Battista Venturi, Italian Physicist, 1746-1822) and the gas is injected, suspended, or dissolved in the flowing liquid. This result is an example of “Bernoulli's principle,” (Daniel Bernoulli, Swiss mathematician, 1700-1782), which suggests that where an incompressible flow through a constricting pipe occurs, there is an increase in kinetic energy and an associated reduction in pressure, which causes a vacuum, and causes air from the entry portions to be sucked into the flowing liquid and thereby dissolved, suspended, and/or injected into the flowing liquid. Accordingly, bubbles and/or micro-bubbles are created in the flowing liquid.

Although FIGS. 4a, 4b and 4d depict a venturi member 430 having two entry portions, in some embodiments, a venturi member 430 may comprise one or more entry portions. Accordingly, in various embodiments, the first and second intake tube branch 420, 425 may be absent or be present in a plurality. Therefore, it should be clear that in various embodiments, pipe architecture as described herein may be modified to accommodate a venturi member 430 having one or more entry portion. (e.g. FIG. 4c). In various embodiments, a venturi member 430 may be obtained from Mazzei Injector Company, LLC (Bakersfield, Calif.).

Although a venturi member 430 is depicted as being an exemplary apparatus that facilitates introduction, combination, mixture or other comingling of gas and liquid, various other systems and apparatus may be used to achieve a similar purpose. In general, such a gas combining apparatus may be or may comprise a bubbler, a bubble reactor, a gas injector, a gas tank, a gas pump, a sparger, and the like.

Returning to the description of FIG. 4a, once the flowing liquid has passed through the venturi member 430 and bubbles or micro-bubbles have been dissolved, suspended, and/or injected into the flowing liquid, the liquid passes into the third pipe length 435 and is expelled through the extrusion orifice 440, which is defined by a bend or sweep in the terminal end of the third pipe length 435. In some embodiments, the extrusion orifice 440 may not be defined by a bend or sweep in the third pipe length 435, and may instead be defined by an opening in the third pipe length 435, and the like.

The extrusion orifice 440 is configured such that liquid flowing out of the extrusion orifice 440 is directed toward the bottom of internal surface of the pod shell 210, which thereby causes a liquid flow comprising micro-bubbles to move about the circumference of the internal surface of pod shell 210, and further causes liquid comprising micro-bubbles to be expelled from the ejection nozzles 290A, 290B located about the lower circumference of the pod shell 210. Accordingly, in embodiments where the aeration pod 100 is located in a body of liquid, liquid comprising micro-bubbles is expelled into the body of liquid. For example, in one embodiment the body of liquid may be a liquid waste pond 140.

In some embodiments, the extrusion orifice 440 may be configured such that liquid flowing out of the extrusion orifice 440 is directed toward the pod base 270, or various portions of the pod shell 210. In such embodiments, liquid comprising bubbles and/or micro bubbles may be expelled from the ejection nozzles 290A, 290B located about the lower circumference of the pod shell 210 as pressure and liquid volume builds within the interior of the pod shell 210.

Similarly, FIG. 4b depicts an aeration pod 100 wherein liquid leaves the pump apparatus 310 though the top of the pump apparatus 310 and into a pre-venturi pipe sweep 410, where it continues through the venturi member 430 and out the extrusion orifice 440 as described herein. In the embodiment depicted in FIG. 4b, the first length of pipe 320, the first sweep 330, and the second length of pipe 340 may be absent. In further embodiments, liquid may leave a pump apparatus 310 at various angles, locations, or positions relative to the pod shell 210 and various lengths of pipe and/or sweeps may be present, which facilitate such liquid leaving the pump apparatus 310 to pass through a venturi member 430.

FIG. 4c depicts a similar embodiment of an aeration pod 100, wherein a venturi member 430 comprising a first intake tube branch 420 is connected to the top portion of a pump apparatus 310. As depicted in FIG. 4c, liquid leaves the pump apparatus 310 at a top end and directly enters the venturi member 430, wherein gas is mixed, combined, injected, or otherwise introduced to the liquid, which then passes out of the extrusion orifice 440. In similar embodiments, liquid may enter various pipes or members before entering a venture member 430.

In various embodiments, the extrusion orifice 440 may comprise a sweep or bend, and the extrusion orifice 440 may direct liquid toward the top portion of the internal cavity of the pod shell 210. Liquid comprising gas, bubbles or micro bubbles, may then be expelled from the ejection nozzles 290A, 290B located about the lower circumference of the pod shell 210.

Such a configuration may be desirable because ejection of liquid and bubbles from the ejection nozzles 290A, 290B may be more consistent wherein the liquid and bubble combination is allowed to first mix in an upper portion of the internal portion of the pod shell 210. In various embodiments, a venturi member 430 may be oriented such that the extrusion orifice 440 may be pointed toward a top portion of the internal pod shell 210. For example, there may be additional sweeps, curves or lengths of pipe, and liquid may leave the pump apparatus 310 from various locations or at various angles.

Additionally, while FIG. 4c may depict a venturi member comprising a first intake tube branch 420; however, in various embodiments, the venturi member may comprise two or more intake tube branches 420, 425. Accordingly, in such embodiments, wherein two or more intake tube branches 420, 425 are present, an extrusion orifice may 440 be directed toward a top portion of the pod shell 210.

In some embodiments, the internal cavity of the pod shell 210 is filled, nearly filled, or partially filled with liquid. Where liquid comprising bubbles and/or micro bubbles is ejected or expelled from the extrusion orifice 440, larger bubbles may form within the liquid and these bubbles may rise to the top of the cavity created by the pod shell 210 and thereby create a gas pocket at the top of the internal pod shell 210 cavity.

FIG. 4d depicts an embodiment of an aeration pod 100 comprising a circulation tube 250, wherein the circulation tube 250 has a first end located within the intake screen 260, and a second end that reaches to a position near the top of the internal cavity of the pod shell 210. The circulation tube 250 passes through the intake screen 260, through the pod base 270, and extends to the top of the pod shell 210 where it terminates at the circulation tube 250 second end.

The suction and/or vacuum within the intake screen 260 that is caused by the pump apparatus 310 causes a vacuum within the circulation tube 250, and allows liquid and or gas to be drawn into the second end of the circulation tube 250 at the top of the internal cavity of the pod shell 210.

Accordingly, where there is a gas pocket at the top of the internal pod shell 210 cavity, this gas may be drawn into the circulation tube 250, which thereby reduces the gas pocket at the top of the internal pod shell 210 cavity. This may be desirable in various embodiments because a gas pocket at the top of the internal pod shell 210 cavity may cause the aeration pod 100 to become buoyant and float in a body of liquid, liquid waste pond 140, or the like.

In some embodiments, the circulation tube 250 may be absent. In further embodiments, a circulation tube 250 may be absent and a gas release apparatus may be present. For example, in some embodiments, a gas release apparatus may be present near the top portion of the internal cavity of the pod shell 210 such that any air pocket that forms may be released via the gas release apparatus. In some embodiments, the gas release apparatus may be a hole, a valve, a port, or the like, which allows gas and/or liquid to pass from the inside of the pod shell 210 to the outside of the pod shell 210. Such a release of gas may be at various rates and may be selective. In some embodiments, a butterfly valve may be present on a top portion of the pod shell 210.

Additionally, FIGS. 4a-4d depict embodiments of an aeration pod 100 wherein, the aeration pod 100 further comprises one or more injection port 240. An injection port may be a tube that extends from the underside of the pod base 270, through the pod base 270 and into the internal cavity of the pod shell 210. In one embodiment, gasses, liquids, solids or a combination thereof may be introduced to the internal cavity of the pod shell 210 via the injection port 240. Matter introduced to the internal cavity of the pod shell 210 via the injection port 240 may be mixed, dissolved, suspended, and/or combined with liquid that may be present in the internal cavity of the pod shell 210.

For example, liquid infused with micro bubbles that is being ejected from the extrusion orifice 440 may generate a turbulent environment within the cavity of the pod shell 210, which may further facilitate mixing, combination, or dissolving of various types of matter that may be introduced via the injection port 240. In one embodiment, a flocculant or coagulant may be introduced to the internal cavity of the pod shell 210, which may include alum, aluminum chlorohydrate, aluminum sulfate, calcium oxide, iron (II) sulfate, iron (III) chloride, sodium aluminate, sodium silicate, Chitosan, Moringa oleifera plant material, Papian, Strychnos genus plant material, Isinglass, or the like. In a further embodiment, matter such as carbon dioxide, ash, or an acid may be introduced to the internal cavity of the pod shell 210 via the injection port 240. In one embodiment, the injection port 240 may be absent.

As described herein, air or other gasses may be introduced to the venturi member 430 via the air intake tube 110, which may extend to the surface of a body of liquid and be held at the surface by an air tube snorkel float 115 (as shown in FIG. 1). However, in some embodiments, one or more gas may be introduced to the venturi member 430, which may include various types of gasses such as carbon dioxide, ozone, oxygen, or the like.

In further embodiments, gas may be introduced via the air intake tube 110 via a blower. For example, while various embodiments provide for gas being introduced via natural suction, in some embodiments a blower may actively introduce gas to the aeration pod 100 under pressure. Such an embodiment may be desirable where the aeration pod 100 is submerged at a depth wherein optimal function of a venturi member 430 is reduced due to high water pressure, which is not balanced by sufficient gas pressure. In some embodiments, a blower may be present within the cavity of the aeration pod 100, be submerged but outside the aeration pod 100, may be located out of the water, and the like.

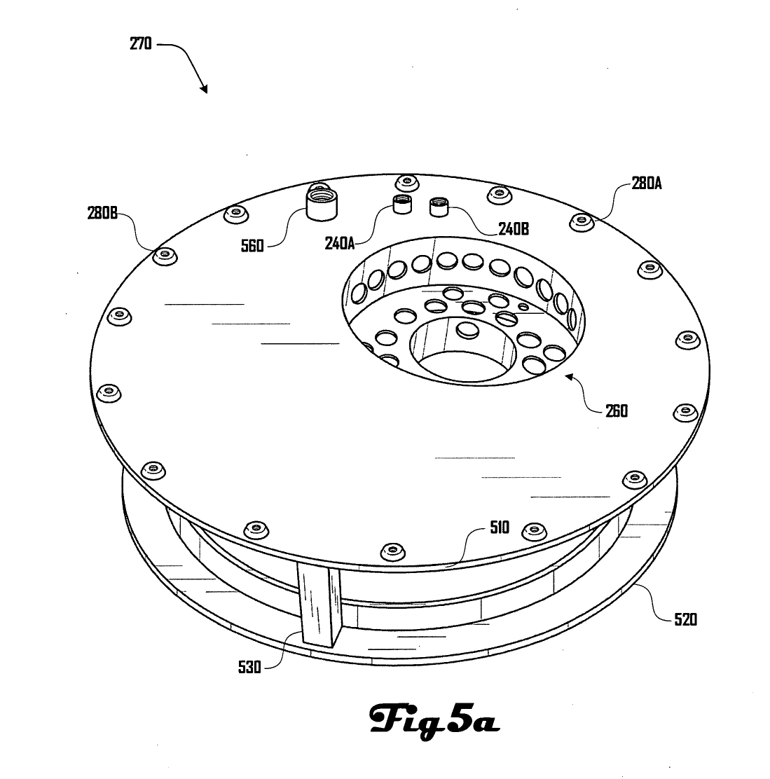

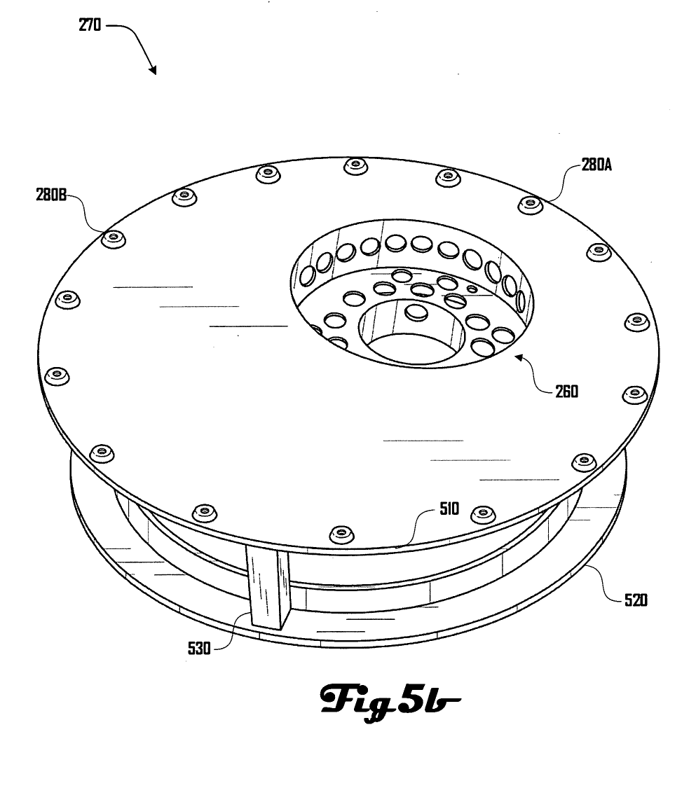

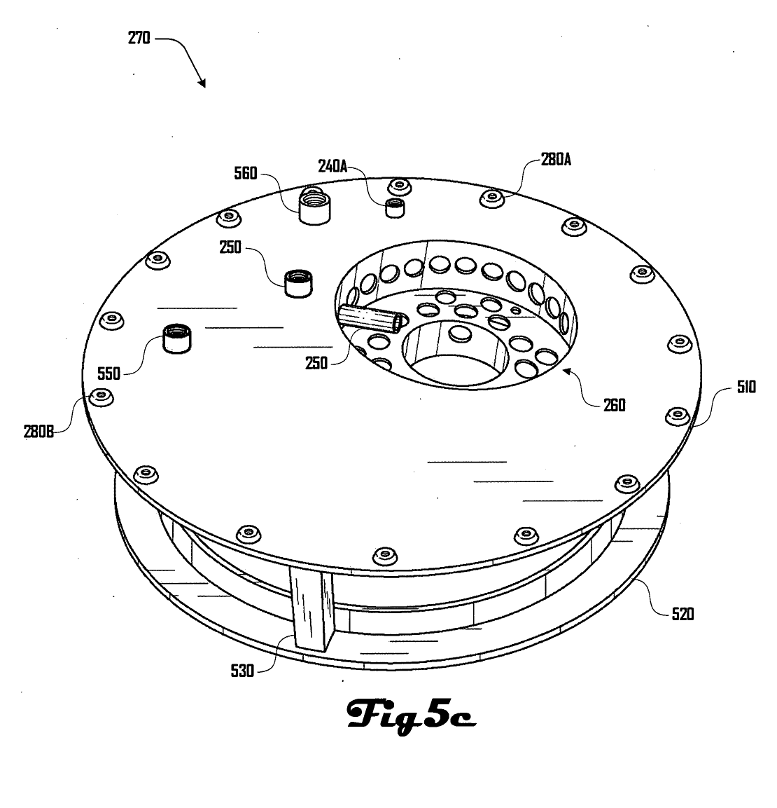

FIGS. 5a-5c depict a perspective view of a pod base 270, in accordance with various embodiments. The pod base 270 comprises pod base plate 510, a pod base foot ring 520, and a foot ring coupling member 530, an intake screen 260, and a plurality of base coupling spacers 280A, 280B.

As depicted in FIGS. 5a-5c, the pod base plate 510 is coupled to the pod base foot ring 520 via one or more foot ring coupling member 530 (multiple foot ring coupling members 530 not visible in this perspective). Additionally, the plurality of base coupling spacers 290A, 290B, facilitate coupling of the pod shell 210 to the pod base 270 and thereby defines a plurality of ejection nozzles 290A, 290B. In another embodiment, there may be various numbers of base coupling spacers 290A, 290B in various configurations, or the base coupling spacers 290A, 290B may be absent.

FIG. 5a depicts a pod base 270 that comprises a power conduit 560 and a first and second injection port 240A, 240B. The power conduit 560 may provide a conduit through which a power cord 130, a pump apparatus power cord 350, or the like may pass and thereby provide a pump apparatus 310 with power. As discussed herein, the first and second injection port 240A, 240B may facilitate injection or otherwise introduction of various types of matter into the internal cavity of the aeration pod 100.

FIG. 5b depicts a pod base 270, wherein a power conduit 560 or injection port 240 are absent. In such an embodiment, a power conduit 560 may be present on another portion of the aeration pod 100 or a power conduit 560 may be absent. In various embodiments, a pump apparatus power cord 350 or power cord 130 may pass through or be attached to an air intake tube 110.

Additionally, in some embodiments, various matter may be introduced into the internal cavity of an aeration pod 100 via one or more injection port 240 located in various locations about the aeration pod 100. In some embodiments, an injection port 240 may be absent.

FIG. 5c depicts a pod base 270 that comprises a support coupling member 550, a circulation tube 250 a power conduit 560, and an injection port 240. The circulation tube 250 is shown extending into the cavity defined by the intake screen 260 and through the top of the pod base plate 510. In some embodiments, the circulation tube 250 may be various lengths and, in various locations, and comprise one or more tube (see, e.g. FIG. 4d).

The support coupling member 550 may provide support to various structures within the aeration pod 100. For example, the support coupling member 550 may couple with a support bar or other structure that may provide support to the pump apparatus 310, the circulation tube 250, first pipe length 320, first pipe sweep 330, second pipe length 340, pre-venturi pipe sweep 410, first intake tube branch 425, second intake tube branch 420, venturi member 430, third pipe length 435, extrusion orifice 440, or the like. In one embodiment, the support coupling member 550 may be absent, or there may be a plurality of support coupling members 550.

In some embodiments, an aeration pod 100 may be movable within a body of liquid. For example, in one embodiment, an aeration pod 100 may be coupled to a line or structure that facilitates the aeration pod 100 being moved back and forth from one end of the line or structure to the other. In another example, an aeration pod 100 may be coupled to a track, which allows one or more aeration pod 100 to move about the track. Such embodiments may be desirable because more even dispersion of bubbles or micro-bubbles generated by the aeration pod 100 may be achieved within a body of liquid.

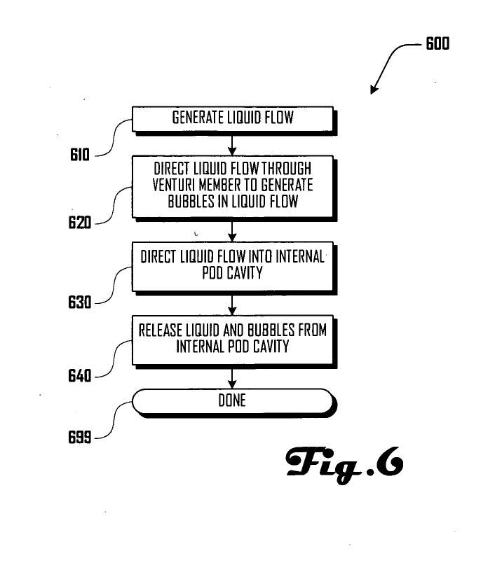

FIG. 6 is a block diagram illustrating a liquid aeration method 600, in accordance with an embodiment. The liquid aeration method 600 begins in block 610 where a liquid flow is generated and continues to block 620 where the liquid flow is directed through a venturi member 430 to generate bubbles in the liquid flow. In block 630, liquid flow with bubbles is directed into an internal pod cavity defined by a pod shell 210 and in block 640 liquid and bubbles are expelled from the internal pod cavity defined by the pod shell 210.

In various embodiments, an aeration pod 100 may be submerged in a liquid waste pond 140 and a liquid flow can be generated from waste water in the liquid waste pond 140. For example, a pump 310 may be used to generate such a wastewater flow. The liquid flow of wastewater can be directed through a venturi member 430 within the aeration pod 100, which may generate bubbles in the liquid flow.

The liquid flow can be directed into the internal cavity of the aeration pod 100 defined by the pod shell 210. In various embodiments, pressure may build in the pod shell 210 due to increased volume of liquid being directed into the internal cavity defined by the pod shell 210, which may force liquid and bubbles out of one or more ejection nozzles 290A, 290B located about the pod shell 210. Accordingly, bubbles and liquid may thereby be expelled from the aeration pod 100 via the ejection nozzles 290A, 290B.

In various embodiments, it may be desirable to direct a generated mixture of wastewater and bubbles into the cavity defined by the pod shell 210 because of increasingly uniform expulsion of bubbles and liquid from the plurality of ejection nozzles 290A, 290B. In embodiments where ejection nozzles 290 are present about the circumference of an aeration pod 100, ejection of bubbles may occur uniformly in 360° about the aeration pod 100. In some embodiments, the venturi member 430 may be a gas combining apparatus operable to combine gas and liquid to form bubbles of various sizes in the liquid.

Additionally, although specific embodiments have been illustrated and described herein, it will be appreciated by those of ordinary skill in the art and others, that a wide variety of alternate and/or equivalent implementations may be substituted for the specific embodiment shown in the described without departing from the scope of the embodiments described herein. This application is intended to cover any adaptations or variations of the embodiment discussed herein. While various embodiments have been illustrated and described, as noted above, many changes may be made without departing from the spirit and scope of the embodiments described herein.

1. A method of aerating a wastewater pond comprising:
submerging an aeration pod in a wastewater pond, said aeration pod comprising:
a pod shell defining an internal pod cavity and having a top end and a bottom end;
a gas combining apparatus within said internal pod cavity operable to generate bubbles in wastewater;
an extrusion orifice within said internal pod cavity connected to said gas combining apparatus operable to release wastewater and bubbles into said internal pod cavity; and
a plurality of nozzles defining a plurality of openings between said internal pod cavity and the outside of said aeration pod;
generating a wastewater flow from wastewater obtained from outside said internal pod cavity;
directing said wastewater flow through said gas combining apparatus to generate a wastewater flow comprising bubbles; and
directing said wastewater flow comprising bubbles into said internal pod cavity via said extrusion orifice; and
releasing wastewater comprising bubbles into said wastewater pond via said plurality of nozzles.

2. The method of claim 1, wherein said gas combining apparatus comprises a venturi member.

3. The method of claim 1, wherein said aeration pod further comprises a pump within said internal pod cavity and said pump is operable to generate said wastewater flow.

4. The method of claim 1, wherein said gas combining apparatus is operable to obtain air from above said wastewater pond.

5. The method of claim 1, wherein said extrusion orifice is positioned proximate to said bottom end of said internal pod cavity.

6. The method of claim 1, wherein said extrusion orifice is positioned proximate to said top end of said internal pod cavity.

7. The method of claim 1, further comprising injecting an injection substance into the internal pod cavity such that said injection substance is combined with said combination of bubbles and wastewater within said internal pod cavity.

8. The method of claim 7, further comprising injecting a second injection substance into the internal pod cavity such that said injection substance is combined with said combination of bubbles and wastewater within said internal pod cavity.

9. The method of claim 1, wherein said bubbles are micro-bubbles.

10. The method of claim 1, comprising releasing a gas-pocket formed within said internal pod cavity via a gas release apparatus.

11. An aeration pod intended to be at least partially submerged in a body of liquid and comprising:
a pod shell defining an internal pod cavity and having a top end and a bottom end;
a pump residing within said internal pod cavity operable to obtain liquid from outside said internal pod cavity;
a gas combining apparatus within said internal pod cavity connected to said pump operable to combine gas with said obtained liquid;
an extrusion orifice within said internal pod cavity connected to said gas combining apparatus operable to expel said obtained liquid and said combined gas into said internal pod cavity; and
a plurality of nozzles operable to allow said expelled liquid and gas to pass from said internal pod cavity into said body of liquid.

12. The liquid aeration pod of claim 11, wherein said gas combining apparatus is operable to obtain gas via an air intake tube when the liquid aeration pod is fully submerged in a body of liquid.

13. The liquid aeration pod of claim 11, wherein said gas combining apparatus comprises a venturi member.

14. The liquid aeration pod of claim 11, wherein said extrusion orifice is positioned proximate to said bottom end of said internal pod cavity.

15. The liquid aeration pod of claim 11, wherein said extrusion orifice is positioned proximate to said top end of said internal pod cavity.

16. The liquid aeration pod of claim 11, wherein said pod shell comprises a gas release apparatus.

17. The liquid aeration pod of claim 16, wherein said gas release apparatus is positioned proximate to said top end of said internal pod cavity.

18. The liquid aeration pod of claim 11, further comprising an injection port.

19. The liquid aeration pod of claim 11, further comprising an impeller.

20. The liquid aeration pod of claim 11, wherein said combined gas is a plurality of micro-bubbles within said obtained liquid.
